(19) United States
(12) Patent Application Publication
(10) Pub. No.: US 2025/0376220 A1
(43) Pub. Date: Dec. 11, 2025

(54) REAR FLOOR ASSEMBLY FOR A VEHICLE

(71) Applicant: FORD GLOBAL TECHNOLOGIES, LLC, Dearborn, MI (US)

(72) Inventors: Peyman AGHSSA, Ann Arbor, MI (US); Vijay PACHORE, Troy, MI (US); Scott MAIR, Dearborn, MI (US); Aron GRAJEK, Northville, MI (US); Bin ZHANG, Northville, MI (US); Sean Timothy RYAN, Farmington Hills, MI (US); Ali KANBEROGLU, Plymouth, MI (US); Ga Ram JUN, Ann Arbor, MI (US); Di WU, Canton, MI (US); Vladimir Vladimirovich BOGACHUK, West Bloomfield, MI (US)

(21) Appl. No.: 18/734,684

(22) Filed: Jun. 5, 2024

(51) Int. Cl. B62D 25/20

(52) U.S. Cl. CPC B62D 25/2027

(57) ABSTRACT

A vehicle includes a monolithic rear floor assembly having a rear transverse beam and a first side member joined to the beam and extending forwardly therefrom in a longitudinal direction of the vehicle. The side member has a wheel-well section with a forward segment and a rear segment. The forward segment has a plurality of first ribs arranged in succession in the longitudinal direction and each with an upper U-shaped rib portion and a lower single rib portion extending downwardly from the U-shaped rib portion. The rear segment has a plurality of second ribs arranged in succession in the longitudinal direction and each with a lower, up-side-down U-shaped portion and an upper single rib portion extending upwardly from the up-side-down U-shaped rib portion.

### TECHNICAL FIELD

This disclosure relates to a vehicle rear floor assembly.

### BACKGROUND

Vehicles traditionally had a frame and a body supported on the frame. Today, many light-duty passenger vehicles have a unibody construction in which the body and frame are formed together as a unitary assembly. Unibody construction typically includes multiple steel stampings that are welded together.

### SUMMARY

According to one embodiment, a vehicle includes a monolithic rear floor assembly having a rear transverse beam and a first side member joined to the beam and extending forwardly therefrom in a longitudinal direction of the vehicle. The side member has a wheel-well section with a forward segment and a rear segment. The forward segment has a plurality of first ribs arranged in succession in the longitudinal direction and each with an upper U-shaped rib portion and a lower single rib portion extending downwardly from the U-shaped rib portion. The rear segment has a plurality of second ribs arranged in succession in the longitudinal direction and each with a lower, up-side-down U-shaped portion and an upper single rib portion extending upwardly from the up-side-down U-shaped rib portion.

According to another embodiment, a vehicle includes a rear floor assembly having a rear transverse beam and a first side member joined to the beam and extending forwardly therefrom in a longitudinal direction of the vehicle. The first side member has a first segment with a plurality of first Y-shaped ribs arranged in succession in the longitudinal direction and each oriented upright and having a second segment with a plurality of second Y-shaped ribs arranged in succession in the longitudinal direction and each oriented up-side-down.

According to yet another embodiment, a vehicle includes an integrally formed die-cast rear floor assembly including a rear transverse beam and a first side member joined to the beam and extending forwardly therefrom in a longitudinal direction of the vehicle. The side member has a wheel-well section with a forward segment and a rear segment, wherein the forward segment has a plurality of first ribs arranged in succession in the longitudinal direction and each with an upper U-shaped rib portion and a lower single rib portion extending downwardly from the U-shaped rib portion. The rear segment has a plurality of second ribs arranged in succession in the longitudinal direction and each with a lower, up-side-down U-shaped portion and an upper single rib portion extending upwardly from the up-side-down U-shaped rib portion.

### BRIEF DESCRIPTION OF THE DRAWINGS

FIG. 1 is a perspective view of one embodiment of an example vehicle having a monolithic rear floor assembly.

FIG. 2 is a detail view of a portion of the rear floor assembly of FIG. 1.

### DETAILED DESCRIPTION

Embodiments of the present disclosure are described herein. It is to be understood, however, that the disclosed embodiments are merely examples and other embodiments can take various and alternative forms. The figures are not necessarily to scale; some features could be exaggerated or minimized to show details of particular components. Therefore, specific structural and functional details disclosed herein are not to be interpreted as limiting, but merely as a representative basis for teaching one skilled in the art to variously employ the present invention.

As those of ordinary skill in the art will understand, various features illustrated and described with reference to any one of the figures can be combined with features illustrated in one or more other figures to produce embodiments that are not explicitly illustrated or described. The combinations of features illustrated provide representative embodiments for typical applications. Various combinations and modifications of the features consistent with the teachings of this disclosure, however, could be desired for particular applications or implementations.

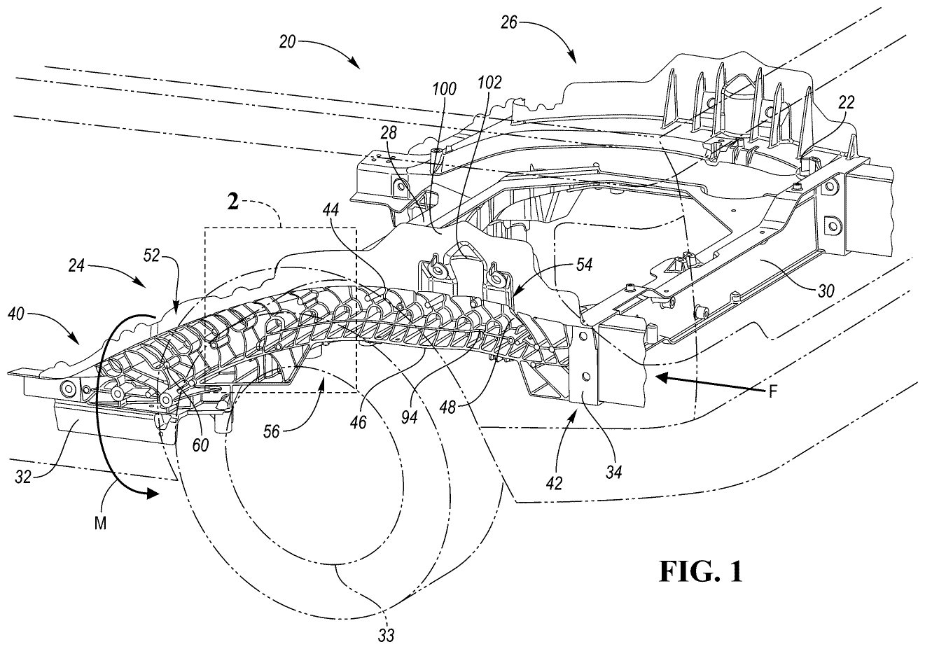

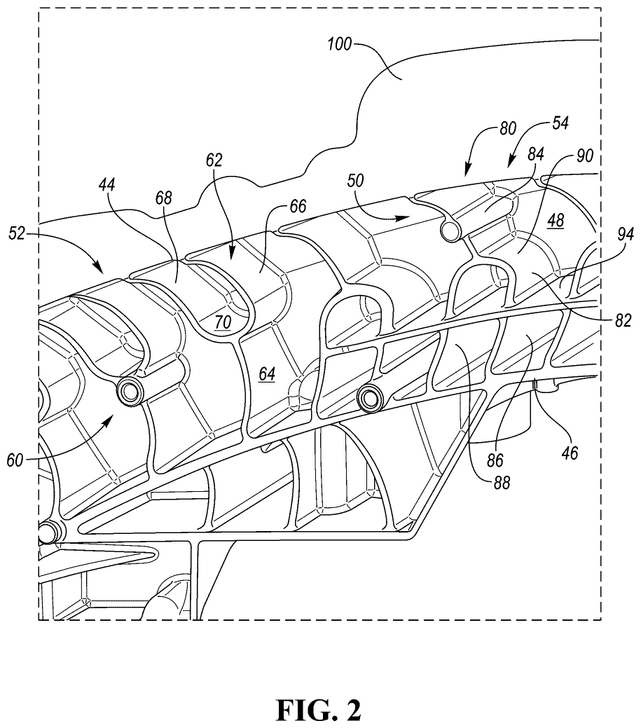

Referring to FIGS. 1 and 2, a vehicle 20 includes structural members as part of a frame, a body, or a unibody. The structural members may provide strength, rigidity, and other desirable attributes for the vehicle. One such structural member is a rear floor assembly 22. The vehicle may be a pickup truck having unibody construction.

The rear floor assembly 22 includes a first side member 24 and the second side member 26 that both extend in the longitudinal direction of the vehicle and are laterally spaced from each other. Front and rear transverse members 28 and 30 are joined to and extend between the side members 24, 26. In the illustrated embodiment, the rear floor assembly 22 has monolithic construction, meaning that all components are integrally formed with each other. For example, the rear floor assembly 22 may be a metal casting, such as a die casting or a high-pressure die casting. In one or more embodiments, the metal casting is an aluminum casting. This monolithic construction is in contrast to traditional construction in which the rear floor assembly is formed of dozens of metal stampings that are welded to each other. By utilizing a casting, the rear floor assembly 22 is a single part instead of being an assembly of 70 to 100 individual parts welded together. This may reduce weight, complexity, and assembly time while providing performance benefits such as strength, rigidity, and the like.

The first side member 24 includes a front attachment 32 configured to join with side rails of the vehicle 20. For example, the front attachment 32 defines a plurality of holes for receiving fasteners used to join the rear floor assembly 22 with the forward portions of the vehicle body or frame. The first side member 24 extends rearwardly from the front attachment 32 to a rear attachment 34 located near the intersection of the side member 24 and the rear beam 30. The rear attachment 34 defines a receiving area, e.g., the shown rectangular receiving area, for receiving a crush can or tubular member associated with a rear bumper or other structural component depending upon the length of the vehicle. The attachment 34 may define fastener holes for connecting the rear floor assembly 22 with the bumper or extension member via fasteners, e.g., bolts.

The first side member 24 may curve upwardly from the front 40 to the back 42 such that the front attachment 32 is lower than the rear attachment 34. The upward curvature provides clearance for the rear axle assembly 33 and suspension components. The first side member 24 may have an open tubular shape generally extending from the front 40 to the back 42 of the floor assembly 22. For example, the side member 24 may include a top member 44, a bottom member 46, and a wall member 48 that extends from the top member 44 to the bottom member 46. The top member 44, bottom member 46, and wall member 48 cooperate to define a cavity 50.

Disposed within the cavity 50 are a plurality of reinforcing ribs. The ribs structural reinforce the side member 24 to increase rigidity and strength and to limit deformation of the rear floor assembly 22 during usage. Monolithic and cast constructions of the rear floor assembly may be more brittle than stamping constructions and the ribs reduce bending and other deformations. As we disclosed in more detail below, the shape, spacing, and orientation of the ribs are strategically placed at various points of the side member 24 to increase bending resistance and provide overall structural strength.

When a force (F) is applied to the bumper attachment 34 moment (M) is generated in the forward segment 52 of the side member 24 due to the vertical offset between the lower front attachment 32 and the higher rear attachment 34. Strategic placement, shape and orientation of the ribs is provided to offset this moment to ensure optimal performance of the rear floor assembly 22. For example, the ribs provided in the forward segment 52 may differ from the ribs provided in the rearward segment 54. Providing different ribs in the forward segment 52 and the rear segment 54 counteracts the moment (M) created by the force (F).

In the illustrated example, the side member 24 is curved to create a wheel-well section 56 that includes the forward segment 52 and the rear segment 54. The forward segment 52 has a plurality of first ribs 60 arranged in succession in the longitudinal direction of the vehicle. Each of the ribs 60 may have an overall Y-shape that is oriented upright. For example, the Y-shaped ribs 60 may include an upper U-shaped rib portion 62 and a lower single rib portion 64 extending downwardly from the U-shaped rib portion 60. The U-shaped rib portion 62 is oriented upright and has a pair of legs 66 and 68 joined by a curve 70. The lower rib portion 64 is joined near or at a midpoint of the curve 70. The legs 66, 68 may be straight or may also have a slight curvature. The legs 66, 68 may curve is a same direction (e.g., forward, as shown in the example).

The rear segment 54 may have a plurality of second ribs 80 arranged in succession in the longitudinal direction of the vehicle. Each of the ribs 80 may have an overall Y-shape that is oriented up-side-down. (Used herein, “upright” and “up-side-down” do not require a vertical orientation but rather contemplate angled orientations too as shown in the figures. That is, a rib is oriented “upright” if it is angled less than 90 degrees of straight up relative to the ground, and a rib is oriented “up-side-down” if it is angled less than 90 degrees of straight down relative to the ground.) The rib 80 may have a lower, up-side-down U-shaped rib portion 82 and an upper single rib portion 84 extending upwardly from the up-side-down U-shaped rib portion. The U-shaped rib portion 82 is oriented up-side-down and has a pair of legs 86 and 88 joined by a curve 90. The upper rib portion 84 is joined near or at a midpoint of the curve 90. The legs 86, 88 may be straight or may also have a slight curvature.

Thus, in the illustrated example, the ribs 60 of the forward segment 52 are oriented opposite to the ribs 80 of the rear segment 54. In one or more embodiments, the ribs 60 are arranged one after the other in the longitudinal direction of the vehicle along the front segment 52 with all of the ribs being substantially the same size and shape and in the same orientation. At the transition point between the front segment 54 and the rear segment 54, the ribs change orientation by approximately 180 degrees with the ribs 80 being upside down and successively arranged one after the other along the longitudinal direction of the vehicle. All of the ribs 80 may be substantially the same size and shape and are in the same orientation. The U-shaped rib portions provide greater stiffness than the single rib portions and by flipping them the forward section 52 has different characteristics than the rear section 54. In doing so, the side member 24 can be tuned to counteract the moment (M). In addition to providing the Y-shaped ribs in different orientations in the different segments, the performance characteristics of the side member 24 can also be tuned by curving the overall shape of the ribs forward or rearward. In the illustrated example, both the ribs 60 and 80 curve forwardly towards the front 40 of the rear floor assembly 22. The stiffness of the rear segment 52 is further increased by adding an additional longitudinal rib 94 that intersects and joins to each of the lower, up-side-down U-shaped rib portions 82.

Each of the ribs 60 and 80 may be joined to the top member 44, bottom member 46, and wall member 48 and have a width that matches a width of the cavity 56 so that the ribs to not protrude outwardly therefrom, i.e., the ribs are flush or recessed into the cavity 50. For example, the upper U-shaped rib portions 62 are joined to the top member 44, the lower rib portions 64 joined to the bottom member 46, and both the upper and lower portions 62, 64 are joined to the wall member 48. Similarly, the upper rib portions 84 are joined to the top member 44, the lower up-side-down U-shaped rib portions 82 are joined to the bottom member 46 in both the upper and lower portions 82, 84 are joined to the wall member 48.

The forward segment 52 may be shorter (in the longitudinal direction) than the rear segment 54 resulting in the rear segment 54 having more ribs 80. For example, there may be twice as many ribs 80 than ribs 60. In the illustrated embodiment, the heights of the ribs are generally uniform due to the uniform spacing between the upper member 44 and the bottom member 46. In other embodiments, however, the height of the ribs may vary based on the distance between the upper member 44 and the lower member 46. In yet other embodiments, the ribs may not completely extend from the upper member 44 to the lower member 46. The linear density (the number of ribs for a given linear distance) may be uniform within each segment 52, 54 or may vary. Furthermore, the linear density of the ribs 60 may be substantially the same as the ribs 80 as shown in the illustrated embodiment. But, in other embodiments, the linear density of the ribs may differ within the different segments of the side member 24. For example, the linear density of the ribs 60 may be higher than the ribs 80 or vice versa.

The side member 24 may also include structure for supporting the rear suspension. For example, an upwardly extending wall 100 may extend from the top member 44 along at least a portion of the wheel-well section 56. The wall 100 may define a suspension mount 102. This suspension mount 102 may include one or more depressions or cavities formed into the wall 100 as well as holes for receiving fasteners.

While exemplary embodiments are described above, it is not intended that these embodiments describe all possible forms encompassed by the claims. The words used in the specification are words of description rather than limitation, and it is understood that various changes can be made without departing from the spirit and scope of the disclosure. As previously described, the features of various embodiments can be combined to form further embodiments of the invention that may not be explicitly described or illustrated. While various embodiments could have been described as providing advantages or being preferred over other embodiments or prior art implementations with respect to one or more desired characteristics, those of ordinary skill in the art recognize that one or more features or characteristics can be compromised to achieve desired overall system attributes, which depend on the specific application and implementation. These attributes can include, but are not limited to strength, durability, marketability, appearance, packaging, size, serviceability, weight, manufacturability, ease of assembly, etc. As such, embodiments described as less desirable than other embodiments or prior art implementations with respect to one or more characteristics are not outside the scope of the disclosure and can be desirable for particular applications.

What is claimed is:

1. A vehicle comprising:
a monolithic rear floor assembly including:
a rear transverse beam, and
a first side member joined to the beam and extending forwardly therefrom in a longitudinal direction of the vehicle, wherein the side member has a wheel-well section with a forward segment and a rear segment, wherein the forward segment has a plurality of first ribs arranged in succession in the longitudinal direction and each with an upper U-shaped rib portion and a lower single rib portion extending downwardly from the U-shaped rib portion, and wherein the rear segment has a plurality of second ribs arranged in succession in the longitudinal direction and each with a lower, up-side-down U-shaped portion and an upper single rib portion extending upwardly from the up-side-down U-shaped rib portion.

2. The vehicle of claim 1, wherein the wheel-well section includes a top member and a bottom member that cooperate to define a cavity, wherein the first ribs are disposed in the cavity with the upper U-shaped rib portions joined to the top member and with the lower rib portions joined to the bottom member, and wherein the second ribs are disposed in the cavity with the lower up-side-down U-shaped rib portions joined to the bottom member and with the upper rib portions joined to the top member.

3. The vehicle of claim 2, wherein the wheel-well section includes a wall extending upwardly from the top member and defining a suspension mount.

4. The vehicle of claim 1, wherein the wheel-well section further has a longitudinal rib intersecting and joined to each of the lower, up-side-down U-shaped rib portions.

5. The vehicle of claim 1, wherein the monolithic rear floor assembly is a casting including aluminum.

6. The vehicle of claim 1, wherein the wheel-well section includes more second ribs than first ribs.

7. The vehicle of claim 1, wherein the wheel-well section includes twice as many second ribs as first ribs.

8. The vehicle of claim 1, wherein the upper U-shaped rib portion is curved forwardly in the longitudinal direction.

9. The vehicle of claim 1, wherein the rear segment is longer than the forward segment.

10. The vehicle of claim 1, wherein the rear floor assembly further includes a second side member joined to the beam and extending forwardly therefrom in the longitudinal direction of the vehicle, wherein the second side member has a second wheel-well section with a second forward segment and a second rear segment, wherein the second forward segment has a plurality of first ribs arranged in succession in the longitudinal direction and each with an upper U-shaped rib portion and a lower single rib portion extending downwardly from the U-shaped rib portion, and wherein the second rear segment has a plurality of second ribs arranged in succession in the longitudinal direction and each with a lower, up-side-down U-shaped portion and an upper single rib portion extending upwardly from the up-side-down U-shaped rib portion.

11. A vehicle comprising:
a rear floor assembly including:
a rear transverse beam, and
a first side member joined to the beam and extending forwardly therefrom in a longitudinal direction of the vehicle, the first side member having a first segment with a plurality of first Y-shaped ribs arranged in succession in the longitudinal direction and each oriented upright and having a second segment with a plurality of second Y-shaped ribs arranged in succession in the longitudinal direction and each oriented up-side-down.

12. The vehicle of claim 11, wherein the first segment is forward of the second segment.

13. The vehicle of claim 11, wherein the first and second segments at least partially define a wheel-well section of the side member.

14. The vehicle of claim 11, wherein the first side member includes a top member and a bottom member that cooperate to define a cavity and wherein the first and second plurality of ribs are disposed in the cavity with each joined to both the top member and the bottom member.

15. The vehicle of claim 11, wherein the assembly further includes a second side member joined to the rear transverse beam and extending forwardly therefrom in the longitudinal direction of the vehicle and wherein the second side member has a first segment with a plurality of first Y-shaped ribs arranged in succession in the longitudinal direction and each oriented upright and having a second segment with a plurality of second Y-shaped ribs arranged in succession in the longitudinal direction and each oriented up-side-down.

16. The vehicle of claim 15, wherein the first segments are forward of the second segments.

17. The vehicle of claim 11, wherein the second segment has a longitudinal rib intersecting and joined to each of the second Y-shaped ribs.

18. The vehicle of claim 11, wherein the rear floor assembly is an aluminum casting.

19. A vehicle comprising:
an integrally formed die-cast rear floor assembly including:
a rear transverse beam, and
a first side member joined to the beam and extending forwardly therefrom in a longitudinal direction of the vehicle, wherein the side member has a wheel-well section with a forward segment and a rear segment, wherein the forward segment has a plurality of first ribs arranged in succession in the longitudinal direction and each with an upper U-shaped rib portion and a lower single rib portion extending downwardly from the U-shaped rib portion, and wherein the rear segment has a plurality of second ribs arranged in succession in the longitudinal direction and each with a lower, up-side-down U-shaped portion and an upper single rib portion extending upwardly from the up-side-down U-shaped rib portion.

20. The vehicle of claim 19, wherein the first side member includes a top member and a bottom member that cooperate to define a cavity and wherein the first and second plurality of ribs are disposed in the cavity with each joined to both the top member and the bottom member.
